(19) United States
(12) Patent Application Publication
(10) Pub. No.: US 2015/0225125 A1
(43) Pub. Date: Aug. 13, 2015

(54) BUCKET SPOUT

(71) Applicant: Tannere Martinisko, Big Bar, CA (US)

(72) Inventor: Tannere Martinisko, Big Bar, CA (US)

(21) Appl. No.: 14/179,433

(22) Filed: Feb. 12, 2014

(51) Int. Cl. B65D 25/50; B67C 11/00; B65D 25/28

(52) U.S. Cl. CPC B65D 25/50; B65D 25/28; B67C 11/00; B65D 2525/285

(57) ABSTRACT

A bucket spout for use with containers or buckets is disclosed. The bucket spout comprises a lid for a conventional bucket that includes a spout that resembles a watering can. The lid can be attached and detached as needed, which provides a means of turning a conventional bucket into a watering can or funneled pourer. The device snaps onto the top of a bucket for a quick and convenient setup, and alleviates the hassle of using a funnel. This prevents people from spilling the contents of a bucket while pouring, and is ideal for anyone that frequently uses a bucket, including gardeners, professional landscapers, painters, and mechanics.

### RELATED APPLICATIONS

This application claims benefit of priority to U.S. Provisional Patent Application No. 61/764,012 entitled “BUCKET SPOUT”, filed Feb. 13, 2013, the aforementioned priority application being hereby incorporated by reference in its entirety.

### BACKGROUND OF THE INVENTION

1. Field of the Invention

This invention relates to a cover or lid for a bucket. More specifically, to a cover which is a uniquely designed bucket lid having an integrated funnel spout and a removable spigot head.

2. Summary of the Prior Art

Buckets are generally used for pouring fluids into a desired location wherein it can be difficult to pour water and other contents from a bucket without spilling or making a mess. Some people may use a funnel, but funnels are unsteady and require a second person to hold them in place. Traditional watering cans may be too small for many projects, and are difficult to fill up in a sink with a faucet due to the partial, non-removable opening in the top.

It is well known that a spout allows people to easily pour water or other contents from a can or bucket without any hassle. Therefore, a need exists to provide a lid having a spout for use with buckets to pour water or any type of liquid which is cost effective and hassle free.

### SUMMARY OF THE INVENTION

A bucket spout for use with containers or buckets is disclosed. The bucket spout comprises a lid for a conventional bucket that includes a spout that resembles a watering can. The lid can be attached and detached as needed, which provides a means of turning a conventional bucket into a watering can or funneled pourer. The device snaps onto the top of a bucket for a quick and convenient setup, and alleviates the hassle of using a funnel. This prevents people from spilling the contents of a bucket while pouring, and is ideal for anyone that frequently uses a bucket, including gardeners, professional landscapers, painters, and mechanics.

### BRIEF DESCRIPTION OF THE DRAWINGS

Further objects and advantages of the present invention will become apparent as the following description of the illustrative embodiments takes place, in which:

FIG. 1 is a perspective view of a drawing showing the lid with spout, spigot head and bucket strap in accordance with the present invention;

FIG. 2 is a back view of a drawing showing the lid with spout, and bucket strap attached for use with a bucket in accordance with an embodiment of the present invention;

FIG. 3 is a side view of a drawing showing the lid with spout, spigot head and bucket strap attached for use with a bucket in accordance with an embodiment of the present invention;

FIG. 4 is a front view of a drawing showing the lid with spout, and bucket strap attached for use with a bucket in accordance with an embodiment of the present invention;

FIGS. 5 is a top view of a drawing showing the lid with spout and one half of which is open to enable ease of pouring; and

FIGS. 6 is a top view of a drawing showing the bucket strap which is used to lift heavy buckets in accordance with another preferred embodiment of the invention.

### DESCRIPTION OF A PREFERRED EMBODIMENT

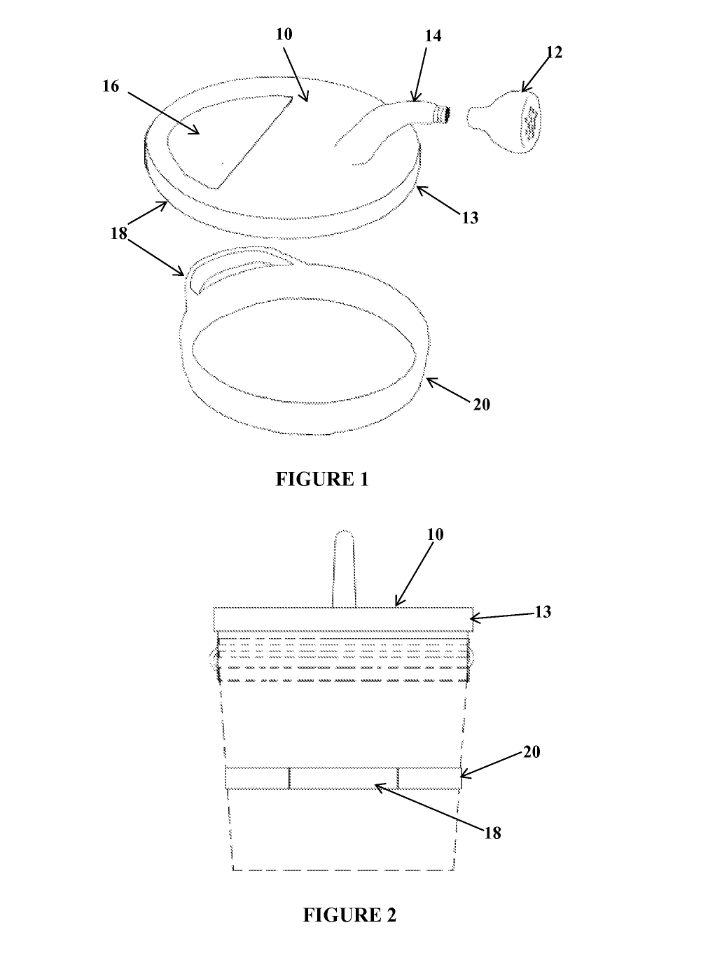

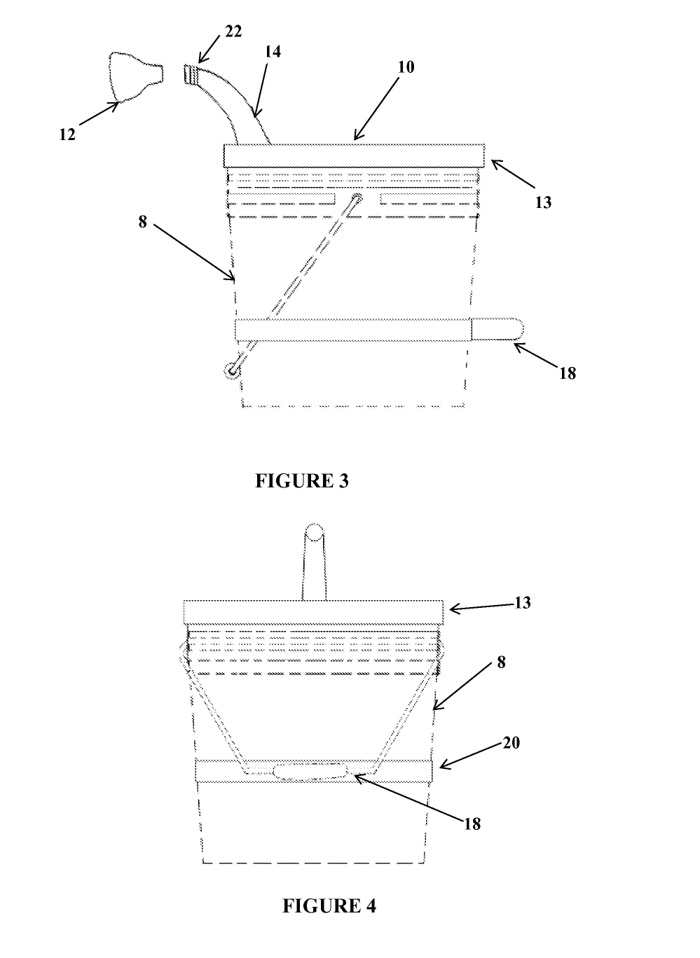

Referring now to FIGS. 1 through 6, there is shown a device 8 comprising a generally cylindrically shaped lid 10 having a bucket spout 14, spigot head 12 and bucket strap 20 in accordance with the present invention. The device 8 comprises a lid 10 sized to fit the top portion of a can or a conventional bucket that includes a spout 14 that resembles a watering can. The lid 10 may be attached and detached to the bucket, which provides a means of turning a conventional bucket into a funneled pourer. Turning once again to FIG. 1, the device 8 also includes a removable spigot head 12 that turns the funnel spout into a watering can. This enables the device 8 to be used in a variety of ways for pouring a fluid.

Referring now to FIGS. 2 through 4, there is shown a view of the components of the present invention in use with a bucket or can 11. The device 8 is comprised of a snap-on lid 10, which is constructed of molded plastic or other suitable material. The snap-on lid 10 has a locking clamp (not shown) located along a rim 13 of the lid 10 for grabbing and securely fastening to the bucket when it is attached for pouring. Similarly, by releasing the locking clamp (not shown) the lid 10 easily pops off for cleaning or to be used on another bucket. The device 8 can be adapted for use on various sized buckets, such as a 5-gallon bucket. Once again, extending from one side of the lid 10 is a funneled spout 12 with a male-threaded fitting 22 on the end. On the opposite side of the lid 10 is a cutout opening 16 for pouring liquids therein.

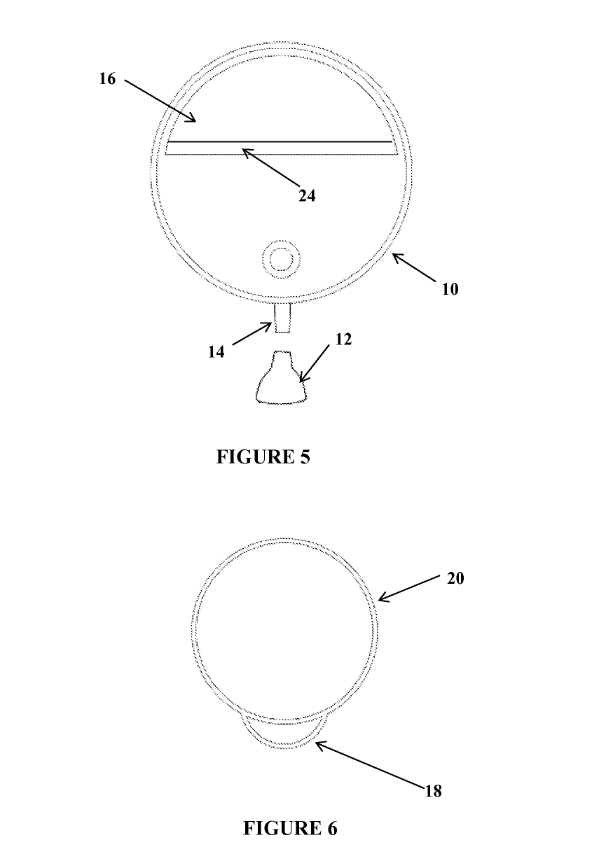

Referring now to FIGS. 5 and 6, there is shown top views of the lid 10 and bucket strap 20 in accordance with one preferred embodiment of the present invention. As shown in FIG. 5 the spigot head 12 is attached by being threaded onto the funneled spout 14 of the present invention. The opening 16 in the lid is used to fill the bucket with water, plant food, cleaning solution, or any other pourable substance. Removable attachments, such as the previously shown and described spigot head 12, with a female-threaded fitting can be applied to the male end of the funneled spout 14 to facilitate easy pouring.

If the bucket becomes too heavy to lift, users can slide a specially designed strap 20 shown in FIG. 6, made of nylon or other suitable material, around the lower end of the bucket as shown in FIGS. 2 through 4. The strap 20 preferably includes a cutout handle 18 on the side for easy gripping. In this way, the present invention allows users to easily pour water or other contents from a bucket without any hassle. The exact specifications may vary upon manufacturing.

In another preferred embodiment there may a slidable portion 24 of lid 10 that covers the open portion 16 such that the lid is completely closes and covers the bucket thereby storing the liquid within the container from evaporating or becoming contaminated.

In summary, the bucket spout previously describes provides the following benefits:
Transforms a traditional bucket into an easy-to-use watering can by
   Snapping onto the top of a bucket for a quick and convenient setup.
   Alleviates the hassle of using a funnel.
   Prevents people from spilling the contents of a bucket while pouring.
   Is ideal for anyone that frequently uses a bucket, including gardeners, professional landscapers, painters, and mechanics.

Although particular embodiments of the invention have been shown and described in full here, there is no intention to thereby limit the invention to the details of such embodiments. On the contrary, the intention is to cover all modifications, alternatives, embodiments, usages and equivalents of the subject invention as fall within the spirit and scope of the invention, specification, and the appended claims.

What is claimed is:

1. a bucket spout, comprising:
a generally circularly shaped lid, said lid defining an upwardly extending spout wherein said lid may be attached and detached from a top portion of a bucket for use as a pouring funnel.

2. The bucket spout according to claim 1, wherein said spout has threaded ends for engaging a spigot head wherein said lid makes the bucket into a watering can.

3. The bucket spout according to claim 2 further comprising: a bucket strap having engagement means for securely attaching to the bottom portion of the bucket.

4. The bucket spout according to claim 3 wherein said strap defines a handle for use in lifting heavy buckets.

5. The bucket spout according to claim 4 further comprising: said bucket strap is fabricated from nylon.

6. The bucket spout according to claim 5 wherein up to one half of said lid defines an open portion for allowing ease of pouring.

7. The bucket spout according to claim 6 further comprising: wherein said lid provides for a slide-able portion for closing the opening thereby covering liquids housed within the bucket.

8. The bucket spout according to claim 1 further comprising: said lid is fabricated from plastic.
